(19) United States
(12) Patent Application Publication
(10) Pub. No.: US 2013/0332884 A1
(43) Pub. Date: Dec. 12, 2013

(54) DISPLAY CONTROL APPARATUS AND CONTROL METHOD THEREOF

(71) Applicant: CANON KABUSHIKI KAISHA, Tokyo (JP)

(72) Inventor: Emi Hitosuga, Tokyo (JP)

(73) Assignee: CANON KABUSHIKI KAISHA, Tokyo (JP)

(21) Appl. No.: 13/903,664

(22) Filed: May 28, 2013

(30) Foreign Application Priority Data
Jun. 7, 2012 (JP) 2012-130096

(51) Int. Cl. G06F 3/0482

(52) U.S. Cl. CPC G06F 3/0482
USPC 715/810

(57) ABSTRACT

A display control apparatus displays, when a user can select an item through a plurality of operation members, related information on a selected item at a timing that the user feels more comfortable according to an operation unit through which the user has selected the item. The display control apparatus includes a control unit for controlling a display unit to display, when an item among a plurality of the selectable items displayed on the display unit is selected in response to an operation different from a touching operation, related information on the selected item in response to the elapse of a first time period after the operation is performed, and when an item among the plurality of selectable items is selected in response to the touching operation, the related information on the selected item before the elapse of the first time period from when the touching operation is performed.

### BACKGROUND OF THE INVENTION

1. Field of the Invention

The present invention relates to a display control apparatus capable of displaying related information on a selected item among a plurality of displayed items and a control method thereof.

2. Description of the Related Art

Functions of electronic apparatuses have become diversified and complicated, and it is not easy for users to master functions of an electronic apparatus. In a case of selecting an item from a plurality of selectable items displayed on a display, if a user cannot understand details of each item, it is difficult for the user to select a desired item. Japanese Patent Application Laid-Open No. 2008-152345 discusses a technique for displaying a pop-up window of a lower layer menu of a focused menu item when a predetermined time period has elapsed since the focus for selection was stopped at any of a plurality of menu items.

In Japanese Patent Application Laid-Open No. 2008-152345, related information on a selected item among a plurality of displayed items is displayed, so that the user can easily judge whether the selected item is a desired item. Furthermore, the timing of displaying the related information is set in such a manner that the related information is displayed when a predetermined time period has elapsed since the focus was stopped. Thus, the related item being displayed can be prevented from being switched frequently while the user feels that the user is still performing an operation.

However, in a case where there is a plurality of operation units to perform a selection operation, if related information is displayed when a fixed time period has elapsed since a selection operation was performed through any operation unit, suitable information is not always displayed for an operation of each operation unit.

For example, in a case where a selection operation is performed by touching an item among a plurality of items displayed on a touch panel, it is assumed that the selection operation is finished when a user's finger is removed from the touch panel. If, nevertheless, related information on the selected item is displayed long after the removal of the finger from the touch panel, the user feels that the response is slow.

On the other hand, in a case where a selection operation is performed by operating a button and the selection operations are performed on a plurality of buttons one after another, the same operation button may be pressed several times as a series of operations. Therefore, even when pressing of the operation button is once finished, it cannot instantly be determined that the selection operation has been finished. Hence, when related information on the selected item is displayed shortly after pressing of the operation button is finished, information that is irrelevant to an item that the user desires may be displayed during a series of user operations. This is confusing.

### SUMMARY OF THE INVENTION

The present invention is directed to a display control apparatus capable of displaying related information on a selected item at a timing a user feels comfortable based on an operation unit used to select the item in a case where the item selection can be performed through a plurality of operation members.

In an aspect of the present invention, a display control apparatus includes: a display control unit configured to control such that a display unit displays a plurality of selectable items; a first operation acceptance unit configured to accept a first operation performed on the display unit; a second operation acceptance unit configured to accept a second operation; and a control unit configured to control such that when an item among the plurality of selectable items is selected in response to the second operation, related information on the item selected is displayed in response to an elapse of a first time period from performance of the second operation, and when an item among the plurality of selectable items is selected in response to the first operation, related information on the item selected is displayed before an elapse of the first time period from performance of the first operation.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a digital camera as a display control apparatus according to an exemplary embodiment of the present invention.

FIG. 2A is an external view of the back side of the digital camera as a display control apparatus according to an exemplary embodiment of the present invention. FIG. 2B is an external view of the front side of the digital camera as a display control apparatus according to an exemplary embodiment of the present invention.

FIG. 3 (3A+3B) is a flow chart illustrating processing of a white balance (WB) setting screen.

FIGS. 4A to 4C are display examples of the WB setting screen.

FIGS. 5A to 5C are display examples of a multi-display screen.

### DESCRIPTION OF THE EMBODIMENTS

Various exemplary embodiments, features, and aspects of the invention will be described in detail below with reference to the drawings.

It is to be noted that the following exemplary embodiment is merely one example for implementing the present invention and can be appropriately modified or changed depending on individual constructions and various conditions of apparatuses to which the present invention is applied. Thus, the present invention is in no way limited to the following exemplary embodiment.

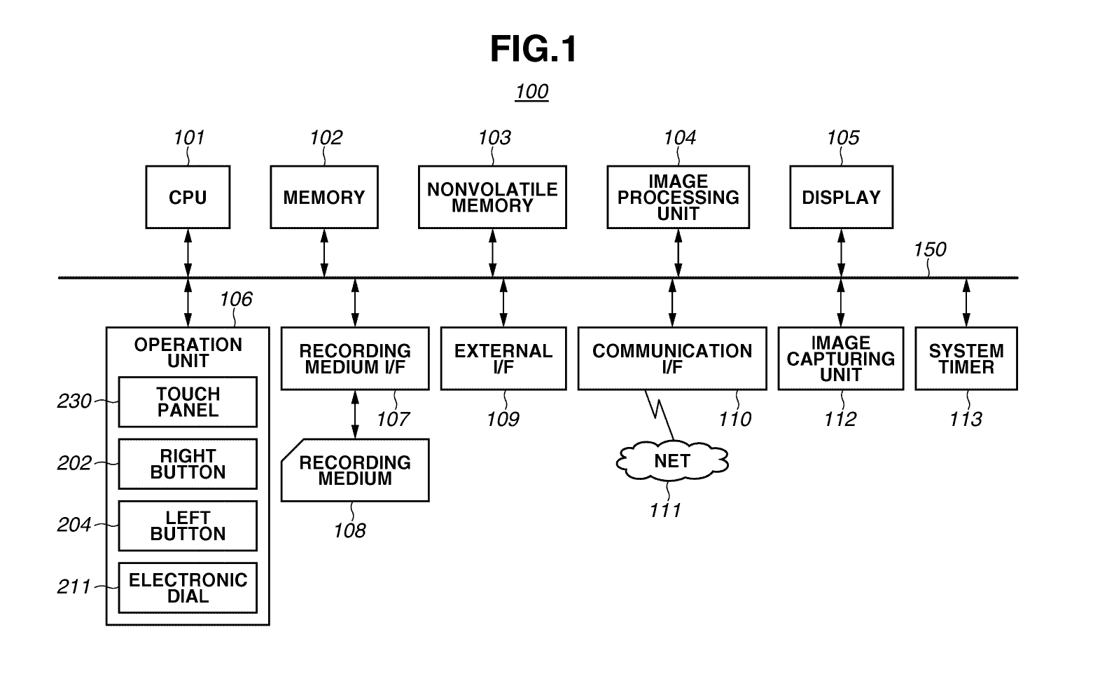

FIG. 1 is a system block diagram of a digital camera 100 as an example of a display control apparatus according to an exemplary embodiment of the present invention. In FIG. 1, a central processing unit (CPU) 101, a memory 102, a nonvolatile memory 103, an image processing unit 104, a display 105, an operation unit 106, and a recording medium interface (I/F) 107 are connected to an internal bus 150. Furthermore, an external I/F 109, a communication I/F 110, an image capturing unit 112, and a system timer 113 are connected to the internal bus 150. The units connected to the internal bus 150 are configured to be capable of exchanging data between one another via the internal bus 150.

The memory 102 is configured of, for example, a random access memory (RAM) (volatile memory using semiconductor device). The CPU 101 controls each unit of the digital camera 100 according to a program stored in, for example, the nonvolatile memory 103 by use of the memory 102 as a work memory. The nonvolatile memory 103 stores image data, audio data, other data, various programs for the CPU 101 to operate, and the like. The nonvolatile memory 103 also records time period t1 to t3, which will be described below. The nonvolatile memory 103 is configured of, for example, a hard disk (HD) and a read only memory (ROM).

Based on the control of the CPU 101, the image processing unit 104 performs various kinds of image processing on data such as image data stored in the recording medium 108, image data obtained via the external I/F 109 or the communication I/F 110, and image data captured by the image capturing unit 112. The image processing performed by the image processing unit 104 includes analog-to-digital (A/D) conversion processing, digital-to-analog (D/A) conversion processing, and encoding processing, compression processing, decoding processing, enlarging/reducing processing (resizing), noise reduction processing, and color conversion processing of image data. The image processing unit 104 may be configured of a dedicated circuit block for performing specific image processing. Some types of image processing can be performed by the CPU 101 according to a program without using a dedicated circuit block.

Based on the control of the CPU 101, the display 105 displays an image and a graphical user interface (GUI) screen configuring a GUI. The CPU 101 generates a display control signal according to a program to control each unit of the digital camera 100 so that a video signal for displaying a video image on the display 105 is generated and output to the display 105. The display 105 displays a video image based on the video signal thus input. The digital camera 100 may include only an interface configured to output a video signal for displaying a video image on the display 105, and the display 105 may be an external monitor (e.g., television).

The operation unit 106 is an input device configured to accept a user operation. The operation unit 106 includes a touch panel 230, which is a pointing device, a right button 202, a left button 204, and an electronic dial 211. The operation unit 106 also includes a joy stick, a touch sensor, a touchpad, a power switch, and a shutter button. The operation unit 106 may also include a text information input device, such as a keyboard, and a mouse (pointing device). The touch panel 230 is an input device that is superposed flatly on the display 105 and configured to output coordinate information corresponding to a touched position.

On the recording medium I/F 107, a recording medium 108 such as a memory card, a compact disk (CD), and a digital versatile disc (DVD) can be mounted. Based on the control of the CPU 101, the recording medium I/F 107 reads and writes data from/on the mounted recording medium 108. The external I/F 109 is an interface connected to an external apparatus via a wired cable or wirelessly to input and output a video signal and an audio signal. The communication I/F 110 is an interface configured to communicate with an external apparatus, an internet 111 and the like to transmit and receive various kinds of data such as a file and a command. The image capturing unit 112 includes at least an image sensor for converting an optical image into an electrical signal, such as a charge coupled device (CCD) and a complementary metal oxide semiconductor (CMOS) device, and includes optical members such as a zoom lens, a focus lens, a mirror, a diaphragm, and a shutter. The system timer 113 is a timer configured to perform time measurement of a clock function built in the digital camera 100 and to measure a control period of each control.

The touch panel 230 and the display 105 can be formed integrally. For example, the touch panel 230 is configured to have a light transmissivity that does not obstruct a display on the display 105, and is mounted on an upper layer of a display surface of the display 105. Then, input coordinates on the touch panel 230 are associated with display coordinates on the display 105. This can configure a GUI that allows a user to directly operate a screen displayed on the display 105. The CPU 101 is capable of detecting the following operations performed on the touch panel 230:

the touch panel 230 is touched with a finger or a pen (hereinafter, referred to as “touch-down”);

the touch panel 230 is being touched with a finger or a pen (hereinafter, referred to as “touch-on”);

the touch panel 230 is touched with a finger or a pen moving on the touch panel 230 (hereinafter, referred to as “touch-move”);

the touch panel 230 is touched with a finger or a pen then being removed from the touch panel 230 (hereinafter, referred to as “touch-up”); and

the touch panel 230 is not touched (hereinafter, referred to as “touch-off”).

The CPU 101 is notified via the internal bus 150 of the above operations and coordinates of a position on the touch panel 230 where a finger or a pen is touching. Based on the information thus notified, the CPU 101 determines what operation has been performed on the touch panel 230. As to the touch-move operation, vertical and horizontal components of the direction in which a finger or a pen is moved on the touch panel 230 can be determined based on a change in the position coordinates. Further, when a user performs touch-down and then a predetermined amount of touch-move followed by touch-up on the touch panel 230, the CPU determines that a stroke has been drawn. An operation to draw the stroke quickly is called a flick. The flick is an operation that a finger is moved quickly on the touch panel 230 for some distance while touching the touch panel 230 and then is removed from the touch panel 230. In other words, the flick is an operation that a user quickly moves his finger on the touch panel 230 to flip the touch panel 230 with the finger. If the CPU 101 detects touch-move for a predetermined distance or longer at a predetermined speed or higher followed by touch-up, the CPU 101 determines that the flick operation has been performed. Further, if the CPU 101 detects touch-move for a predetermined distance or longer at a speed lower than a predetermined speed, the CPU 101 determines that a drag operation has been performed. A touch panel of any type can be used as the touch panel 230 such as resistance film type, capacitance type, surface acoustic wave type, infrared-ray type, electromagnetic induction type, image recognition type, and optical sensor type touch panels among various types of touch panels.

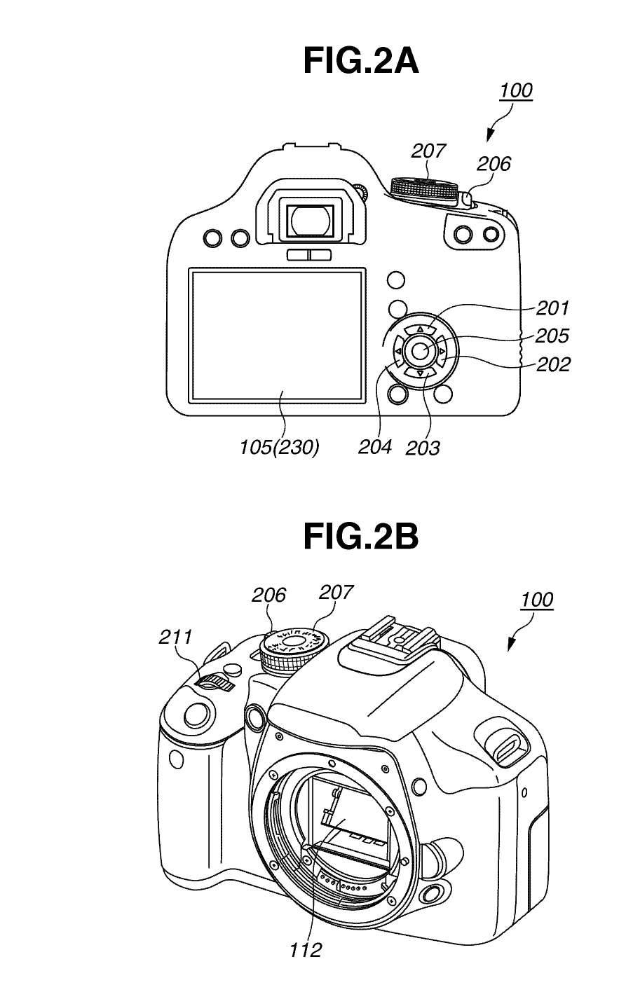

FIG. 2A illustrates an external view of the back side of the digital camera 100, and FIG. 2B illustrates an external view of the front side of the digital camera 100.

The display 105 is a display unit configured to display an image and various kinds of information. The display 105 is formed integrally with the touch panel 230. The operation unit 106 illustrated in FIG. 1 includes operation members such as the up button 201, the right button 202, the down button 203, the left button 204, the set button 205, and the electronic dial 211. Hereinafter, the up button 201, the right button 202, the down button 203, and the left button 204 will collectively be referred to as arrow keys. The right button 202 and the left button 204 will collectively be referred to as a left/right key. The up button 201 and the down button 203 will collectively be referred to as up/down keys. The electronic dial 211 is a rotation operation member (rotary encoder) that can be rotated clockwise or anticlockwise. The set button 205 is used mainly to change or determine a setting value. A power switch 206 is an operation unit configured to switch between power-on and power-off of the digital camera 100. A mode dial 207 is an operation unit configured to switch between various modes of the digital camera 100. The image capturing unit 112 includes a mirror illustrated in FIG. 2B (the mirror can be omitted), an image sensor positioned at the back of the mirror, and the like. An interchangeable lens can be mounted on this portion.

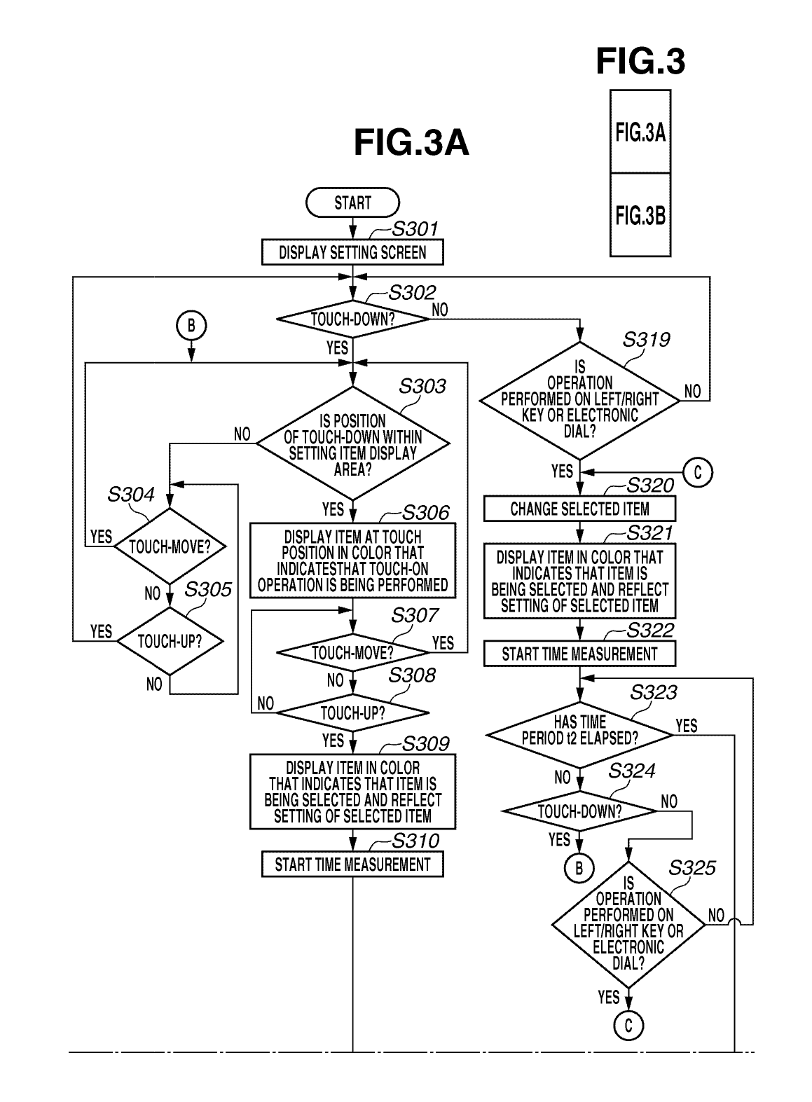

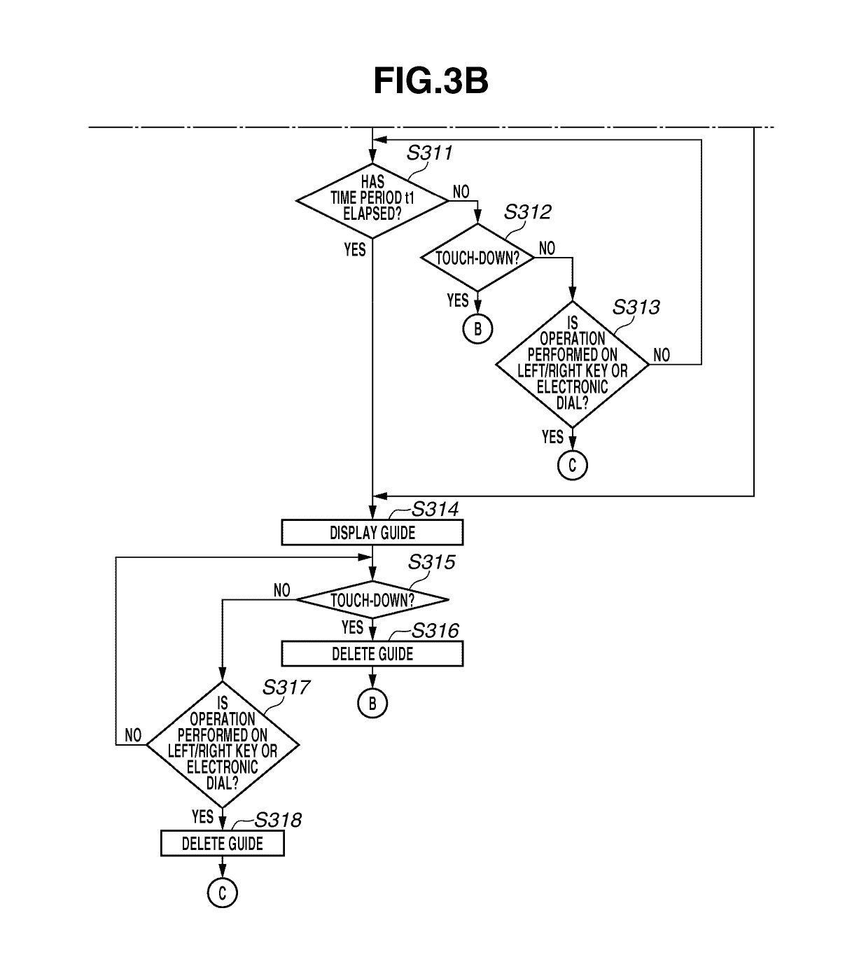

Operations according to a first exemplary embodiment will be described below with reference to FIGS. 3 to FIG. 5C.

In the present exemplary embodiment, a state will be described in which an item is selected from a plurality of items displayed as setting candidates on a screen for changing a white balance (hereinafter “WB”) setting. In the present exemplary embodiment, a period of time that is set to elapse until guide information on a selected WB setting is displayed is changed depending on whether the WB setting has been selected through a touching operation on the touch panel 230 or through an operation on the left/right key or the electronic dial 211.

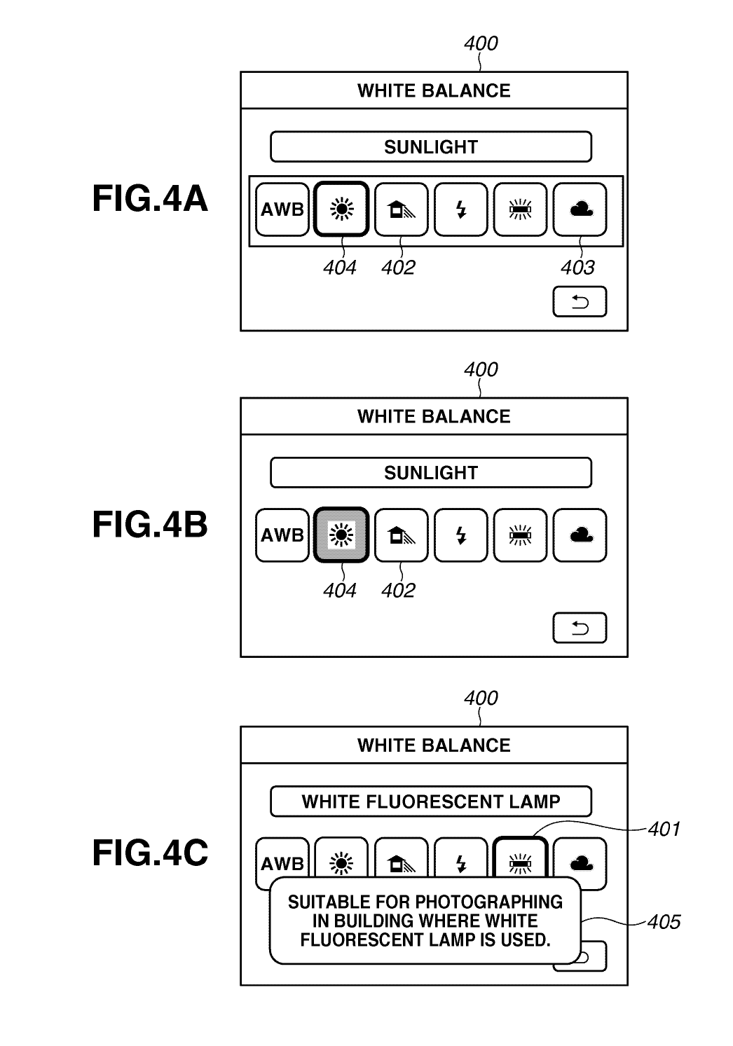

FIG. 3 (3A+3B) illustrates a flowchart of processing of a WB setting screen, and FIGS. 4A to 4C illustrate various examples of what are displayed on the WB setting screen. When a user activates the digital camera 100 and operates the operation unit 106 to give an instruction to start displaying the WB setting screen, the CPU 101 executes a display control program stored in the memory 102 to display the WB setting screen on the display 105, whereby the processing illustrated in FIG. 3 is started.

In step S301, the CPU 101 displays an initial screen of the WB setting screen on the display 105.

FIG. 4A illustrates an example of an initial display screen of a WB setting screen 400 on the display 105. In a setting item display area 403, a plurality of WB setting value candidates for different light sources are displayed as a plurality of selectable items. In FIG. 4A, icons indicating auto white balance (AWB), sunlight, shade, flash photography, white fluorescent lamp, and cloudiness in this order from the left are aligned as setting value candidates (items). In FIG. 4A, the sunlight is selected among the above icons, and the item of sunlight is displayed with a selection frame as a selected state display form 401. The display form is not limited to the selection frame of the selected state display form 401, and any display form that is discriminable from items that are not being selected (for example, item of a shade 402) can be used. Examples include a flashing display and a display in a different color. From the above state, it is understood that the sunlight (WB setting suitable for a light source with a color temperature of about 5200 degrees Kelvin) is set as the WB setting of the digital camera 100.

In step S302, the CPU 101 determines whether the user has performed touch-down on the touch panel 230. If the user has performed touch-down (YES in step S302), then the processing proceeds to step S303 (first operation acceptance). If the user has not performed touch-down (NO in step S302), then the processing proceeds to step S319.

In step S303, the CPU 101 determines whether the position of the touch-down performed by the user in step S302 is within the setting item display area 403. If the position is within the setting item display area 403 (YES in step S303), then the processing proceeds to step S306. If the position is not within the setting item display area 403 (NO in step S303), then the processing proceeds to step S304.

In step S304, the CPU 101 determines whether the user has performed touch-move. If the user has performed touch-move (YES in step S304), then the processing proceeds to step S303 again. If the user has not performed touch-move (NO in step S304), then the processing proceeds to step S305.

In step S305, the CPU 101 determines whether the user has performed touch-up. If the user has performed touch-up (YES in step S305), then the processing proceeds to step S302 again. If the user has not performed touch-up (NO in step S305), then the processing proceeds to step S304.

In step S306, the CPU 101 displays an item at a touch position (position being touched) in a display form in a color that indicates that touch-on is in progress.

FIG. 4B illustrates a display example of the WB setting screen 400 displayed on the display 105 during touch-on. FIG. 4B is a display example in a case where the item of sunlight is being touched. A touch-on state display 404 of the sunlight is different in color of an inner portion of the item from the color during touch-off. This makes the touch-on state display 404 discriminable from the selected state display form 401, which is the display form displayed during touch-off. The touch-on state display 404 is also discriminable from items that are not being selected (for example, the item of shade 402). The display form allows the user to understand that the user is currently touching the item of sunlight and the touching operation that the user is currently performing is accepted by the digital camera 100.

In step S307, the CPU 101 determines whether the user has performed touch-move. If the user has performed touch-move (YES in step S307), then the processing proceeds to step S303 again. If the user has not performed touch-move (NO in step S307), then the processing proceeds to step S308.

In step S308, the CPU 101 determines whether the user has performed touch-up. If the user has performed touch-up (YES in step S308), then the processing proceeds to step S309. If the user has not performed touch-up (NO in step S308), then the processing proceeds to step S307 again.

In step S309, the CPU 101 changes the display form of the item at the position (touch-up position) that was touched immediately before the touch-up in step S308 from the display form during touch-on to the selected state display form 401, which is the display form during touch-off, thereby displaying the item in the selected state display form 401. Furthermore, the CPU 101 sets a setting value (WB setting) indicated by the item at the touch-up position to the digital camera 100.

In step S310, the CPU 101 starts time measurement (the timer is started). More specifically, the CPU 101 obtains time information at this start point from the system timer 113 and stores the time information in the memory 102. From a difference between the time information thus stored and time information obtained during the subsequent time measurement, a time period that has elapsed since the timer was started can be determined.

In step S311, the CPU 101 determines whether a time period t1 has elapsed since the timer was started. If the time period t1 has elapsed (YES in step S311), then the processing proceeds to step S314. If the time period t1 has not elapsed (NO in step S311), then the processing proceeds to step S312. The time period t1 is shorter than a time period t2, which will be described below (t1<t2). The time period t1 is a time period from the time of touch-up from the touch panel 230 to finish the selection operation to the time when related information on the selected item is displayed. The time period t1 is, for example, about 0.2 seconds. If this time period is excessively long, the user may feel that the response is slow. Further, since the time period t1 is only required to be shorter than the time period t2, the time period t1 may be 0 second. In order not to give unnaturalness to the user, however, the time period t1 may have a substantial time period that is not 0 second.

In step S312, the CPU 101 determines whether the user has performed touch-down. If the user has performed touch-down (YES in step S312), then the processing proceeds to step S303 again. If the user has not performed touch-down (NO in step S312), then the processing proceeds to step S313.

In step S313, the CPU 101 determines whether the user has pressed the left/right key (either one of the right button 202 and the left button 204) or rotated the electronic dial 211. If the user has pressed the left/right key or rotated the electronic dial 211 (YES in step S313), then the processing proceeds to step S320. If the user has neither pressed the left/right key nor rotated the electronic dial 211 (NO in step S313), then the processing proceeds to step S311.

In step S314, the CPU 101 displays a guide 405 of the selected item as related information on the selected item on the display 105. The guide is displayed after touch-up but not during touch-on.

FIG. 4C illustrates a display example of the guide 405 in the WB setting screen 400. The guide 405 displays a guide message describing details of the setting of the selected item (item displayed in the selected state display form 401). In the example illustrated in FIG. 4C, since the item of white fluorescent lamp is selected and displayed in the selected state display form 401, the guide 405 describes that the WB setting of the selected item is suitable for capturing an image in a building where a white fluorescent lamp is used. From the guide 405 thus displayed, the user can judge whether the currently selected item is a desired item.

In step S315, the CPU 101 determines whether the user has performed touch-down. If the user has performed touch-down (YES in step S315), then the processing proceeds to step S316. If the user has not performed touch-down (NO instep S315), then the processing proceeds to step S317.

In step S316, the CPU 101 deletes the guide 405 displayed in step S314 (the guide 405 is not displayed), and the processing proceeds to step S303.

In step S317, the CPU 101 determines whether the user has pressed the left/right key (either one of the right button 202 and the left button 204) or rotated the electronic dial 211. If the user has pressed the left/right key or rotated the electronic dial 211 (YES in step S317), then the processing proceeds to step S318. If the user has neither pressed the left/right key nor rotated the electronic dial 211 (NO in step S317), then the processing proceeds to step S315 again.

In step S318, the CPU 101 deletes the guide 405 displayed in step S314 (the guide 405 is not displayed), and the processing proceeds to step S320.

On the other hand, in step S319, the CPU 101 determines whether the user has pressed the left/right key (either one of the right button 202 and the left button 204) or rotated the electronic dial 211. If the user has pressed the left/right key or rotated the electronic dial 211 (if a physical operation has been accepted) (YES in step S319), then the processing proceeds to step S320 (second operation acceptance). If the user has neither pressed the left/right key nor rotated the electronic dial 211 (NO in step S319), then the processing proceeds to step S302 again.

In step S320, the CPU 101 changes an item to be selected according to whether the user has pressed the left/right key or rotated the electronic dial 211. More specifically, if the user has pressed the right button 202, the CPU 101 selects an adjacent item on the right side of the item that was selected before the pressing. If the user has pressed the left button 204, the CPU 101 selects an adjacent item on the left side of the item that was selected before the pressing. If the user has rotated the electronic dial 211 clockwise, the CPU 101 moves the selection frame to the right according to the amount of rotation. If the user has rotated the electronic dial 211 anticlockwise, the CPU 101 moves the selection frame to the left according to the amount of rotation.

In step S321, the CPU 101 changes the display form of the selected item thus changed to the selected state display form 401, which is the display form during touch-off, thereby displaying the selected item in the selected state display form 401. Furthermore, the CPU 101 sets the setting value (WB setting) of the selected item thus changed to the digital camera 100.

In step S322, the CPU 101 starts time measurement (the timer is started). More specifically, the CPU 101 obtains time information at this start point from the system timer 113 and stores the time information in the memory 102. From a difference between the time information thus stored and time information obtained during the subsequent time measurement, a time period that has elapsed since the timer was started can be determined.

In step S323, the CPU 101 determines whether the time period t2 has elapsed since the timer was started. If the time period t2 has elapsed (YES in step S323), then the processing proceeds to step S314. If the time period t2 has not elapsed (NO in step S323), then the processing proceeds to step S324. The time period t2 (first time period) is longer than the time period t1 (second time period) described above (t1<t2). The time period t2 is a time period from the time when the item to be selected is changed according to whether the user has pressed the left/right key or rotated the electronic dial 211 to the time when related information on the selected item is displayed. The time period t2 is, for example, about 0.8 seconds. If this time period is excessively short, the content of the guide 405 switches successively during a user operation to make the user feel bothered. When the time period is about 0.8 seconds, an operation is likely to be almost finished even if the operation is a continuous operation. Therefore, the user would not feel that the operation is still in progress.

In step S324, the CPU 101 determines whether the user has performed touch-down. If the user has performed touch-down (YES in step S324), then the processing proceeds to step S303. If the user has not performed touch-down (NO instep S324), then the processing proceeds to step S325.

In step S325, the CPU 101 determines whether the user has pressed the left/right key (either one of the right button 202 and the left button 204) or rotated the electronic dial 211. If the user has pressed the left/right key or rotated the electronic dial 211 (YES in step S325), then the processing proceeds to step S320. If the user has neither pressed the left/right key nor rotated the electronic dial 211 (NO in step S325), then the processing proceeds to step S323 again.

In the processing illustrated in FIG. 3, the time period that is set to elapse until the guide 405 of the selected item is displayed is changed according to whether the operation unit through which the user has selected the item from the plurality of items is the touch panel 230, the left/right key, or the electronic dial 211. More specifically, in a case where the user has selected the item through the touch panel 230, the guide 405 is displayed promptly within a shorter time period than that in a case where the user has selected the item through the left/right key or the electronic dial 211. In other words, in the case where an operation member through which an item to be selected can be designated directly has been operated, the guide 405 is displayed in a shorter time period than that in a case where an operation member that sequentially switches a selected item according to the number of operations and the amount of rotation has been operated. Accordingly, when the user selects an item by touching the touch panel 230, the guide 405 is displayed relatively promptly after touch-up. Thus, the user would not feel that the response is slow. Furthermore, the user would not be bothered by the guide 405 being displayed when the user is continuously pressing the left/right key or rotating the electronic dial 211, which leads to the contents of the guide 405 being frequently switched during the operation. Accordingly, related information on the selected item is displayed at the timing that the user feels more comfortable according to the operation unit through which the item has been selected from the plurality of items. This allows comfortable user operation.

In the present exemplary embodiment, the guide 405 is displayed when the time period t2 has elapsed (after YES in step S323) since the operation of the left/right key or the electronic dial 211 was finished in step S302. The guide 405 may be displayed after the elapse of different time periods depending on whether the user operation has been performed through the left/right key or the electronic dial 211. For example, when the operation has been performed through the left/right key (first operation member), the guide 405 is displayed after the time period t2 (first time period: for example, 0.8 seconds) has elapsed. On the other hand, when the operation has been performed through the electronic dial 211 (second operation member), the guide 405 is displayed after a time period t3 (third time period: for example, 0.5 seconds), which is shorter than the time period t2 and longer than the time period t1, has elapsed. In other words, the time period t1 (time period from touch-up to guide display)<the time period t3 (time period from dial operation to guide display)<the time period t2 (time period from button operation to guide display). This relation is set because an interval between continuous rotation operations of the electronic dial 211 is presumed to be shorter than an interval between continuous pressing operations of either one of the left/right key. When the interval between continuous operations is short, even if the time period to elapse before the guide 405 is displayed is set relatively short, the guide 405 is less likely to be displayed frequently during the operations. Accordingly, the time period from the time of the selection operation to the time when the related information on the selected item is displayed is set as appropriate for each operation member through which the user performs the selection operation, whereby the related information can be displayed with more meticulous care at the timing that the user feels comfortable.

Further, as illustrated in FIG. 4C, the guide 405 is displayed to overlap partly on the WB setting value candidate items, which are the plurality of selectable items, so that a guide message can be displayed in a large area. However, the overlapped display during the selection operation disturbs the selection operation because the selection candidate items are not sufficiently visible. In the processing illustrated in FIG. 3, the guide 405 is not displayed during the selection operation (during the acceptance of touching operation, during the operation of the left/right key or the electronic dial 211) so that the guide 405 would not obstruct the selectable items during the selection operation. However, when the guide 405 is displayed at a position where the overlapping of the guide 405 on the selectable items can be avoided, even if the guide 405 is displayed during the selection operation, the guide 405 would not obstruct the selection candidate items. Accordingly, when the guide 405 is displayed at a position where the overlapping of the guide 405 on the selectable items can be avoided, the guide 405 may be displayed also during the selection operation (during touch-on, during the time period t1 from the time of touch-up, during the operation of the left/right key or the electronic dial 211, and during the time period t2 from the time when the operation was finished).

In the first exemplary embodiment described above, the present invention is applied to the WB setting screen of the digital camera 100 in the image capturing mode. The plurality of selectable items is applied to the setting candidates settable as the WB setting, and the related information on the selected item is applied to the guide display of the selected WB setting item. However, the present invention is not limited thereto. In a second exemplary embodiment, the present invention is applied to a multi-display screen where multiple images are displayed on a single screen. The plurality of selectable items is applied to a plurality of displayed images, and the related information on the selected item is applied to an enlarged image of the selected image. The multi-display screen is displayed when the digital camera 100 is in a playback mode.

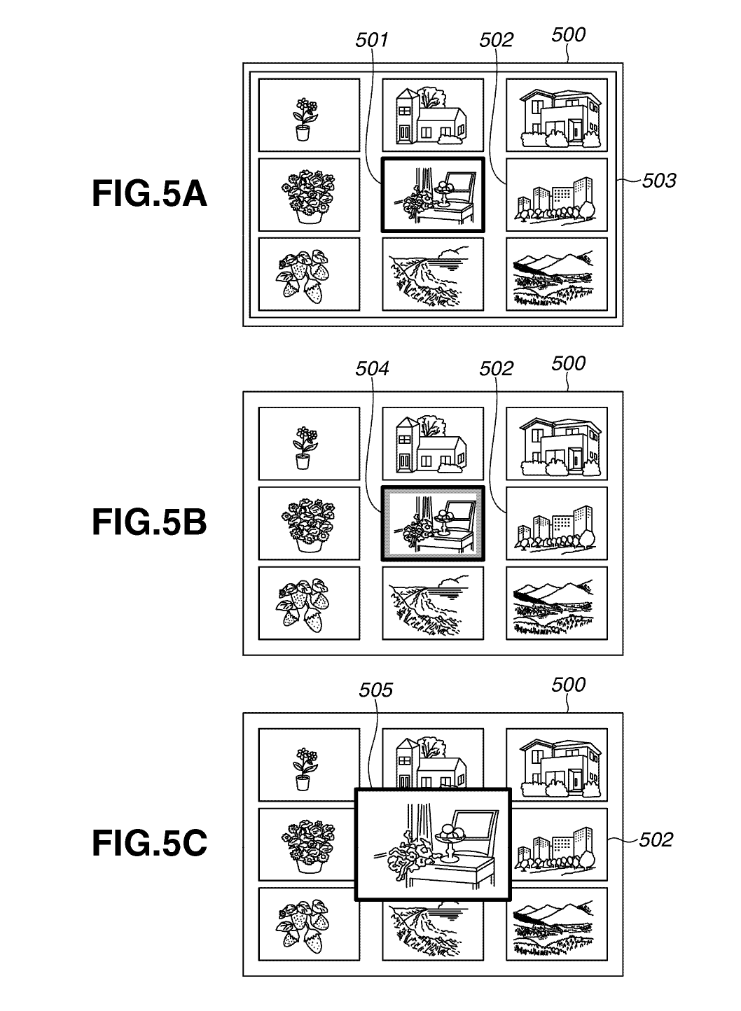

FIGS. 5A to 5C illustrate display examples of the multi-display screen to which the present invention is applicable.

FIG. 5A is a display example of a multi-display screen 500 where nine images are simultaneously displayed as selectable items on the display 105. In FIG. 5A, the image at the center is selected and displayed in a selected state display form 501 (selection frame is displayed) to cause the selected image discriminable from images 502 that are not selected. The user can select an image from the nine images by touching a touchable area 503 of the touch panel 230, pressing the arrow keys of the touch panel 230, or operating the electronic dial 211.

FIG. 5B is a display example of a touch-on state display 504 in a case where a user is touching the image at the center among the images displayed on the multi-display screen 500 (in a touch-on state). The touch-on state display 504 is different in color of an inner portion of the image from the color during touch-off, making the touch-on state display 504 discriminable from the selected state display form 501, which is the display form during touch-off. The touch-on state display 504 is also discriminable from items that are not being selected (e.g., image 502). Such a display form enables the user to understand that the user is currently touching the image at the center and that the touching operation the user is currently performing is being accepted by the digital camera 100.

FIG. 5C is an example in which an enlarged image 505 of the image at the center, which is the item being selected, is displayed as related information on the image. The enlarged image 505 enables the user to check the selected image in more detail and judge whether the currently selected item is a desired item.

When the user presses arrow keys or rotates the electronic dial 211 in the state illustrated in FIG. 5C to change the selection image, the enlarged image (related information) is deleted, and the image being selected is displayed in the selected state display form 501 as illustrated in FIG. 5A (no enlarged image is displayed during the operation). Then, as in the case of displaying the guide 405 in the processing of FIG. 3, the enlarged image of the selected image is displayed when the time period t2 has elapsed since the pressing of the arrow keys or the operation of the electronic dial 211 was finished. On the other hand, when the user presses arrow keys or operates the electronic dial 211 in the state illustrated in FIG. 5C to change the selected image, the enlarged image (related information) is deleted, and the image being selected is displayed in the touch-on state display 504 as illustrated in FIG. 5B (no enlarged image is displayed during the operation). After touch-up, the touch-on state display 504 is first switched to the selected state display form 501 as illustrated in FIG. 5A. Then, as in the case of displaying the guide 405 in the processing illustrated in FIG. 3, the enlarged image of the selected image is displayed when the time period t1 (<t2) has elapsed after touch-up. The processing can be realized by similar processing to the processing performed on the WB setting screen illustrated in FIG. 3 if the enlarged display 505 on the multi-display screen is regarded as similar to the guide 405 on the WB setting screen.

According to the second exemplary embodiment, the enlarged image can be displayed as related information on the selected image at the timing that the user feels comfortable according to the operation unit through which the user has selected the item from the plurality of images. Thus, the user can perform comfortable operation. It is to be noted that although the example is described in which the enlarged image of the selected image is displayed as related information on the selected item, the present invention is not limited thereto. The related information may be attribute information (e.g., image capturing setting information and image capturing position information included in header information) on the selected image or information on other files associated with the selected image.

Furthermore, the operation member is not limited to the touch panel 230, and any operation member that allows a user to directly designate and select a desired item instead of sequential selection can be used. An operation member such as a mouse and a touchpad can also be used in a similar manner to the touch panel 230 in the exemplary embodiments described above.

The control performed by the CPU 101 in the above exemplary embodiments is not limited to the control performed by a single hardware component. The control of the entire apparatus maybe performed by a plurality of hardware components sharing the processing.

The above-described exemplary embodiments are merely examples for implementing the present invention and can be appropriately modified or changed depending on individual constructions and various conditions of apparatuses to which the present invention is applied. Thus, the present invention is in no way limited to the foregoing exemplary embodiments.

In the above-described exemplary embodiments, the examples are described in which the present invention is applied to the digital camera 100. However, the present invention is not limited to the examples. The present invention is also applicable to any display control apparatus that allows a user to select an item from a plurality of selectable items and is capable of displaying related information on the selected item. More specifically, the present invention is applicable to personal computers, personal digital assistants (PDA), mobile phone terminals, portable image viewers, printer apparatuses including a display, digital photo frames, music players, game apparatuses, electronic book readers and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-130096 filed Jun. 7, 2012, which is hereby incorporated by reference herein in its entirety.

What is claimed is:

1. A display control apparatus comprising:
a display control unit configured to control a display unit to display a plurality of selectable items;
a first operation acceptance unit configured to accept a first operation performed on the display unit;
a second operation acceptance unit configured to accept a second operation; and
a control unit configured to control the display unit to display, when an item among the plurality of selectable items is selected in response to the second operation, related information on the selected item in response to an elapse of a first time period from when the second operation was accepted, and when an item among the plurality of selectable items is selected in response to the first operation, the related information on the item selected before an elapse of the first time period from when the first operation was accepted.

2. The display control apparatus according to claim 1, wherein the control unit controls the display unit to display, when an item among the plurality of selectable items is selected in response to the first operation, the related information on the item selected in response to an elapse of a second time period, which is shorter than the first time period, from when a touched state by the first operation is ended.

3. The display control apparatus according to claim 2, further comprising a third operation acceptance unit,
wherein the control unit controls the display unit to display, when an item among the plurality of selectable items is selected in response to an operation performed on the third operation acceptance unit, the related information on the selected item in response to an elapse of a third time period, which is shorter than the first time period and longer than the second time period, from when the third operation acceptance unit accepts the operation.

4. The display control apparatus according to claim 3, wherein the third operation acceptance unit is a rotational operation member.

5. The display control apparatus according to claim 1, wherein the control unit controls the display unit to not display the related information during a touched state by the first operation.

6. The display control apparatus according to claim 1, wherein the control unit controls the display unit to not display, when the second operation acceptance unit accepts an operation to select an item from the plurality of selectable items while the related information is displayed, the related information from when the second operation acceptance unit accepted the operation to when the first time period elapses.

7. The display control apparatus according to claim 1, wherein the control unit performs the control when the related information is displayed in such a manner that at least a part of the related information overlaps on the plurality of selectable items displayed by the display control unit.

8. The display control apparatus according to claim 7, wherein the control unit controls the display unit to display, when the displayed related information does not overlap on the plurality of selectable items displayed by the display control unit, the related information before an elapse of the first time period from when the second operation acceptance unit accepted the operation.

9. The display control apparatus according to claim 1, wherein the related information is a guide display regarding the selected item.

10. The display control apparatus according to claim 1,
wherein the second operation acceptance unit is a push button, and the control unit controls an item to be selected to be switched sequentially according to a number of operations performed on the push button.

11. The display control apparatus according to claim 1,
wherein the second operation acceptance unit is a rotational operation member, and the control unit controls an item to be selected to be switched sequentially according to an amount of rotation of the rotational operation member.

12. The display control apparatus according to claim 1, wherein the display control unit displays on the display unit a plurality of images as the plurality of selectable items, and the control unit controls the display unit to display an enlarged image of an item selected from the plurality of images as the related information.

13. The display control apparatus according to claim 1, wherein the first operation is an operation from when an item is touched to when the item is released from the touch.

14. The display control apparatus according to claim 1, further comprising an image capturing unit,
wherein the display control unit displays a plurality of setting value candidates, which relates to a specific setting item regarding image capturing of the image capturing unit, as the plurality of selectable items, and the control unit controls the display unit to display a guide on a setting value candidate selected from the plurality of setting value candidates as the related information.

15. The display control apparatus according to claim 14, wherein the specific setting item is a white balance.

16. A display control apparatus, comprising:
a display control unit configured to control a display unit to display a plurality of selectable images;
a first operation acceptance unit configured to accept a first operation performed on the display unit;
a second operation acceptance unit configured to accept a second operation; and
a control unit configured to control that the display unit to display, when an image among the plurality of selectable images is selected in response to the second operation, an enlarged image of the selected image in response to an elapse of a first time period from when the second operation acceptance unit accepted the operation, and when an image among the plurality of selectable images is selected in response to the first operation, an enlarged image of the selected image before an elapse of the first time period from when the first operation acceptance unit accepted the first operation.

17. A method of controlling a display control apparatus, comprising:
controlling a display unit to display a plurality of selectable items;
accepting a first operation performed on the display unit;
accepting a second operation; and
controlling the display unit to display, when an item among the plurality of selectable items is selected in response to the second operation, related information on the selected item in response to an elapse of a first time period from performance of the second operation, and when an item among the plurality of selectable items is selected in response to the first operation, the related information on the selected item before an elapse of the first time period from when the first operation is accepted.

18. A method of controlling a display control apparatus, comprising:
controlling a display unit to display a plurality of selectable images;
accepting a first operation performed on the display unit;
accepting a second operation; and
controlling the display unit to display, when an image among the plurality of selectable images is selected in response to the second operation, an enlarged image of the selected image is displayed in response to an elapse of a first time period from when the second operation is accepted, and when an image among the plurality of selectable images is selected in response to the first operation, an enlarged image of the selected image before an elapse of the first time period from when the first operation is accepted.

19. A non-transitory computer-readable recording medium storing a program for causing a computer to execute a control method, the method comprising:
controlling a display unit to display a plurality of selectable items;
accepting a first operation performed on the display unit;
accepting a second operation; and
controlling the display unit to display, when an item among the plurality of selectable items is selected in response to the second operation, related information on the selected item in response to an elapse of a first time period from performance of the second operation, and when an item among the plurality of selectable items is selected in response to the first operation, the related information on the selected item before an elapse of the first time period from when the first operation is accepted.

20. A non-transitory computer-readable recording medium storing a program for causing a computer to execute a control method, the method comprising:
controlling a display unit to display a plurality of selectable images;
accepting a first operation performed on the display unit;
accepting a second operation; and
controlling the display unit to display, when an image among the plurality of selectable images is selected in response to the second operation, an enlarged image of the selected image is displayed in response to an elapse of a first time period from when the second operation is accepted, and when an image among the plurality of selectable images is selected in response to the first operation, an enlarged image of the selected image before an elapse of the first time period from when the first operation is accepted.
